(19) United States
(12) Patent Application Publication
(10) Pub. No.: US 2011/0115276 A1
(43) Pub. Date: May 19, 2011

(54) Air-Conditioned Seat with Trenches and Tensioning Device Therefore

(75) Inventor: Enrico Glaser, Mering (DE)

(73) Assignee: W.E.T. AUTOMOTIVE SYSTEMS AG, Odelzhausen (DE)

(21) Appl. No.: 12/446,010

(22) PCT Filed: Nov. 12, 2007
(86) PCT No.: PCT/DE07/02041

§ 371 Date: Feb. 7, 2011

(30) Foreign Application Priority Data
Nov. 14, 2006 (EP) 10 2006 053 852.8

(51) Int. Cl. B60N 2/58; B60N 2/56; A47C 31/10

(52) U.S. Cl. 297/452.42; 24/72.5

(57) ABSTRACT

This invention relates to a tensioning device (40) for pulling a cover (18) of an interior fitting (1100), particularly a seat (1110), into a trench (27′).

The invention provides for the tensioning device (40) to have at least one tension-transmission device (28) for transmitting tensile forces between the interior of the seat (1110) and the cover (18), at least one anchorage device (29) for fastening the cover (18) directly or indirectly to a cushion and/or the seat (1110), at least one stiffening element (9) for distributing tensile forces of the tension-transmission device (28) uniformly along the pulled-down cover (18), and/or a pressure-distribution device (33) to prevent a concentration of pressure caused by the tensioning device (40) on the functional elements (1) within the seat.

### BACKGROUND OF THE INVENTION

The subject matter of this invention includes an air-conditioned seat with trenches and a tensioning device therefore.

### SUBJECT OF THE INVENTION

Stitched seat covers on air-conditioned seats or other seating furniture with air-ducting layers in the area of the seat or backrest-contact surfaces are often problematic in that the air-conditioning in areas of a seat or backrest surface that are separated from one another by stitching is non-uniform due to insufficient airflow continuity across the seat-cover trenches.

Difficulties are also frequently encountered in realizing 90° angles and smooth cushion edges with known spacer media, so that trenches and cover edges formed by spacer media are not always of neat appearance. It is common practice—as described, for example, in DE 10037065—to use knitted spacer fabrics only in trench-free seat areas, and to separately ventilate, for example by means of mini-fans, each of those seat-area surfaces that are separated from one another by trenches.

If air-ducting layers are nevertheless spanned, for example by point wise anchorage, this often reduces the ventilation efficiency, leads to an unattractive appearance due to differences in trench depth, and/or reduces the service life of electrical components (e.g. the seat heating) near to the surface as a result of increased stress.

One objective of this invention is thus to provide an air-conditioned seat with at least one cushion layer that is sub-divided by optically and haptically acceptable stitching, and to ensure a uniform and sufficient air supply to all of the air-ducting layers beneath the seat's cover fabric while keeping the construction as uncomplicated as possible. In particular, the invention is intended to ensure that the airflow continuity across the seat-cover trenches is good enough to enable a single ventilation device to ventilate all areas of the seat.

This objective of the invention is established with the subject matter of the independent claims 1 and/or 2. Features of useful developments of the invention are evident from the dependent claims and the following description.

The invention permits the use of standardized air-conditioning modules by providing for adaptation to the respective seat design. It also reduces production times and costs, increases the service life of surface-near functional components, and improves the appearance of the seat by way of taut, uniform seams and contours. An arrangement of this kind also makes it possible to route the lines for electrical or fluidic functional components, especially seat-heating, seat-occupied-recognition, pneumatic-seat-adjustment or seat-cooling components, through the recess 27/the tensioning device 40.

### DRAWINGS

Details of the invention are explained in the following. These explanations are intended to elucidate the invention. However, they are only of exemplary nature. The scope of the invention naturally allows for one or more of the described features to be omitted, modified or augmented. And it goes without saying that the features of different embodiments can be combined with each other. What is crucial is that the idea behind the invention is essentially implemented. The term “essentially” means that a particular feature (e.g. of the claims) is implemented to an extent of at least 50%, preferably at least 90%, preferably at least 95% or 99%.

Reference will be made hereinafter to:

FIG. 1 A motor vehicle, partially in longitudinal section

FIG. 2 A longitudinal section through the trench of a seat cushion for the vehicle shown in FIG. 1, in the area denoted by A

FIG. 3 A first embodiment of a tensioning device with nonwoven fabric and plastic strips

FIG. 4 A second embodiment of a tensioning device configured as a plastic profile

FIG. 5 A third embodiment of a tensioning device configured as a wire bow with w-shaped bends

FIG. 6 A fourth embodiment of a tensioning device configured as a wire bow in a tube of non-woven fabric

FIG. 7 A fifth embodiment of a tensioning device, analogous to FIG. 6 but with an additional reinforcing member along the edge of a tape or a tube

FIG. 8 A sixth embodiment of a tensioning device, analogous to FIG. 6 but configured as a wire frame instead of a tube.

### DESCRIPTION OF THE INVENTION

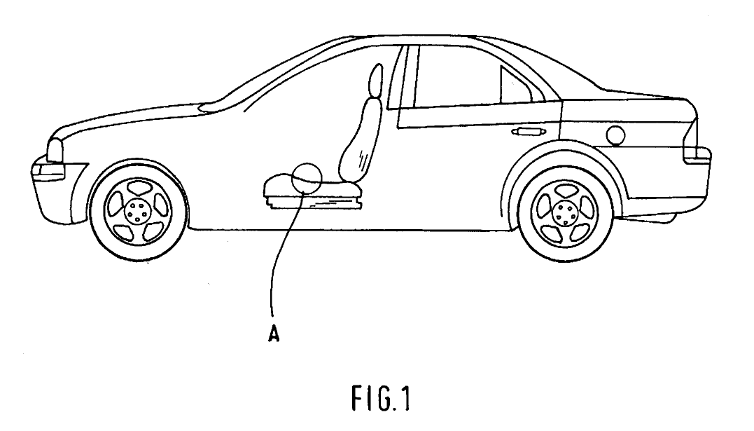

FIG. 1 shows a vehicle 1000. The vehicle can be, for example, an airplane, a rail vehicle, a ship, or, as here, a motor vehicle.

The vehicle 1000 has at least one interior fitting 1100. In case of doubt, interior fittings are defined as all those components with which a user of the passenger compartment can come into contact, such as a steering device for the vehicle, a dashboard, an armrest, a door-trim panel, a seat pad, an electric blanket, a roof lining, a cushion 400, a cover 18 or, as here, a seat 1110.

The interior fitting 1100 preferably has at least one cushion 400 and/or at least one cover 18.

The interior fitting 1100 preferably includes at least one climate-conditioning system 100. This serves, for example, for the temperature control or air conditioning of user-contact surfaces in the passenger compartment of a vehicle. The device has at least one temperature-control means 110, at least one air-ducting means 120 and/or at least one moisture-regulating means 130. The term “temperature-control means” refers to any means that can be used to selectively alter the temperature of its surroundings, e.g. all devices having at least one electrical heating resistor, a heat pump, a Peltier element and/or an air-movement means such as a fan, or that is comprised essentially thereof. The term “air-movement means” refers to any means that can be used to selectively alter the air composition or the airflows in a given surface or spatial area by way of air exchange, e.g. an on-board air-conditioning system, at least partially air-permeable spacer media, knitted spacer fabrics and/or an air-conditioning insert. The term “moisture-regulating means” refers to a means for regulating the humidity of its surroundings, especially the temperature-control means already mentioned and moisture-absorbing substances such as activated carbon fibers and polymeric super absorbers.

A seat 1110 has at least one recess 27. This takes the form of a trench 27′. The trench 27′ is at least partially covered by a cover 18, which is pulled into the trench 27′ by a tensioning device 40.

Beneath the cover 18, a backing 20—for example a foam backing—is provided on both sides of the trench 27′. Above the trench 27′ itself, this backing 20 is at least partially perforated, replaced by a thin material, omitted and/or engineered to be thinner. In this way, a visible trench is formed in the upper seat surface even if there is no recess in the seat cushion. An underlying air-ducting means 14 accordingly need not be pulled so deep into the trench 27′, or can even run horizontally over the area of the trench 27′ without any substantial deflection, embedding in foam or interruption.

The tensioning device 40 preferably has at least one anchorage device 29 for attaching the cover 18, by means of the tensioning device 40, to the cushion or to corresponding fastening means 30. It is preferable to provide at least two, better three, anchorage devices 29 per trench 27′. The anchorage device 29 may be configured as plastic profiles which then engage with corresponding fastening means 30 (FIG. 3). They may also be configured as hooks, holes or eyes (e.g. FIGS. 4 to 8), which then engage a matching hook on the cushion.

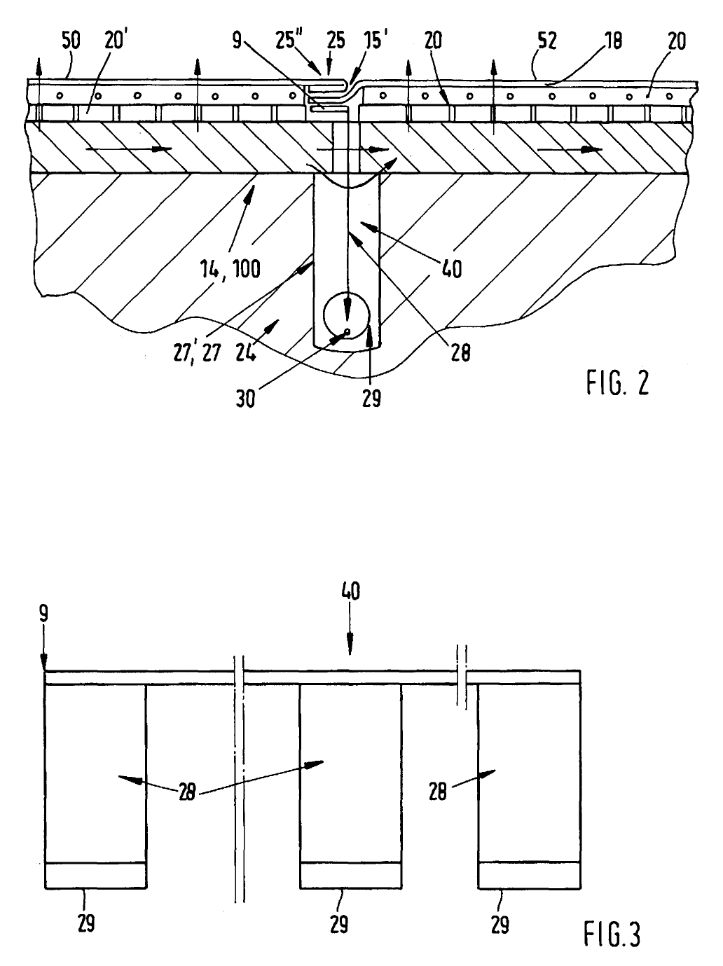

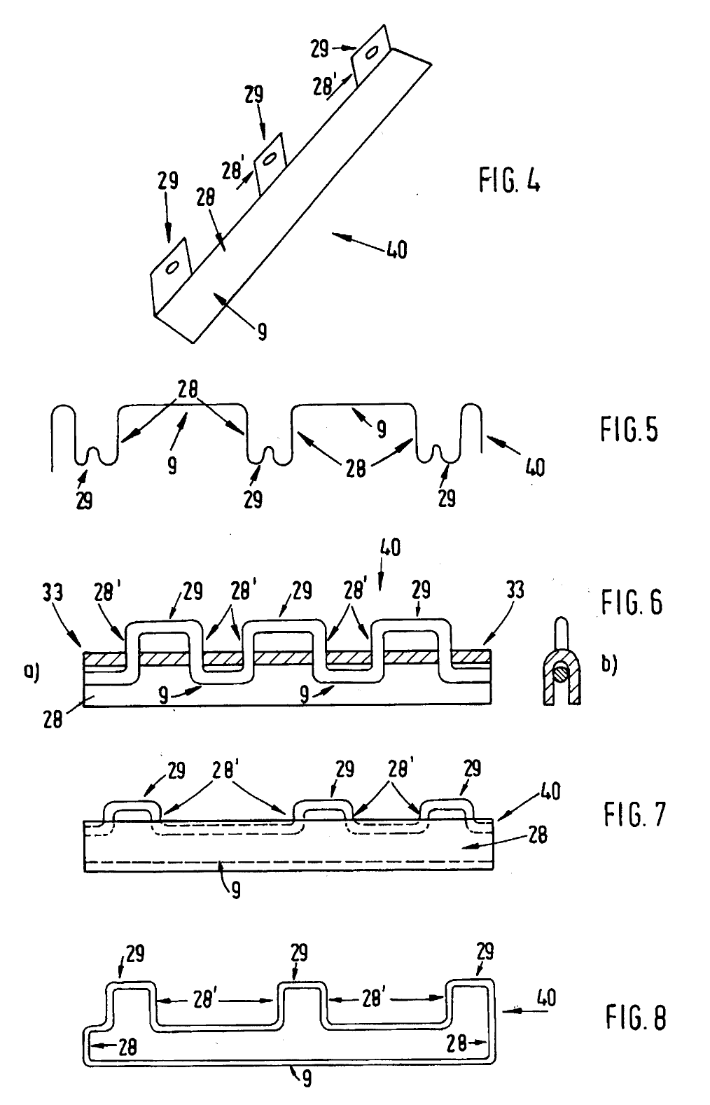

The tensioning device 40 preferably includes at least one stiffening element 9. This ensures the uniform distribution of tensile forces along the pulled-down cover 18. It is preferably shaped and incorporated in such a way as not to be felt by the seat occupant. This can be achieved by using a stiffening element made at least partially of a flexible material and shaped to permit bending, e.g. by using a flat plastic strip as shown in FIGS. 2 and 4, which is positioned approximately parallel to the plane of the cover. Another alternative is to configure the stiffening element 9 as wire, as shown in FIGS. 5 to 8. The stiffening element 9 can then also be incorporated deeper down in the cushion, a distance away from the seat surface (FIG. 6).

The tensioning device 40 preferably includes a tension-transmission device 28, 28′ for transmitting tensile forces from at least one stiffening element 9 to at least one anchorage device 29. This tension-transmission device 28 is preferably formed at least partially by a strip of non-woven or bonded fabric, for example, or another, preferably air-permeable, textile (FIG. 2, 3, 7). In this case, the stiffening element(s) 9 and the anchorage device(s) 29 are arranged on opposing longitudinal edges of the tension-transmission means.

Provision may also be made for the tension-transmission device 28 to have at least one tube-like anchorage tape, preferably a net-like structure, preferably a textile, preferably a braided tube.

However, the tension-transmission means 28, 28′ can also be configured as a plastic strip or to resemble a panel (FIG. 4), or it can be formed by part of the cover 18 itself. Another alternative is to configure the tension-transmission device 28′ as wire or as the wire section of a tensioning bow (FIGS. 5 to 8).

It is to advantage if the tensioning device 40 has at least two tension-transmission devices 28 which are spaced apart from each other and which connect the cover 18 with the rest of the seat 1110, and that the area of the trench 27′ located between the tension-transmission devices 28 is at least partially open for the passage of air, and if the tensioning device 40 has at least two tension-transmission devices 28 which connect the cover 18 with the rest of the seat and that for at least part of the distance between these two tension-transmission devices 28 a flexible reinforcing strip acting as a stiffening element 9 is arranged at the cover 18 in order to ensure that the cover 18 sits uniformly along the length of the trench 27′. This arrangement makes it possible to transmit the tensile forces of the entire trench 27′ via two strands. As a result, the air-ducting layer to be spanned is compartmentalized only to a minimum extent, if at all. At the same time, the tensile force acting between the cover 18 and the cushion is substantially linear thanks to the stiffening elements 9 and the anchorage devices 29.

It is expedient if at least one tensioning device 40 has an air permeability of at least 1 m/s (as per German standard DIN 9237) in the transverse direction, that is, in the direction in which the air-ducting means 14 runs.

The tensioning device 40 preferably has at least one pressure-distribution device 33 in order to distribute the pressure acting on the air-ducting layer or other functional elements beneath the cover over a larger area. This measure prevents localized concentration of pressure. A pressure-distribution device 33 of this kind can be made, for example, of felt upholstery tape, as shown in FIG. 6.

### LIST OF REFERENCE NUMERALS

1 Functional element in the seat
9 Stiffening element
14 Air-ducting means
18 Seat cover (e.g. of perforated leather/fabric)
18 Seat-cover backing (e.g. foam backing)
20 Recess in the cushion body (e.g. a channel in the foamed upholstery)
27′ Trench
28 Tension-transmission device (e.g. of nonwoven fabric)
29 Anchorage device (e.g. hog ring)
30 Fastening means (e.g. embedded in foam)
33 Pressure-distribution device
40 Tensioning device
50 Air-conditioned zone 1
52 Air-conditioned zone 2
100 Climate-conditioning system
110 Temperature-control means
120 Air-ducting means for the climate-conditioning system
130 Moisture-regulating means
400 Cushion
1000 Vehicle
1100 Interior fitting
1110 Seat

1-5. (canceled)

6. A tensioning device for pulling a cover of an interior fitting into a trench, characterized in that the tensioning device has at least one tension-transmission device for transmitting tensile forces between the interior of the interior fitting and the cover, at least one anchorage device for fastening the cover directly or indirectly to a cushion, at least one stiffening element for distributing tensile forces of the tension-transmission device uniformly along the pulled-down cover, and/or a pressure-distribution device to prevent a concentration of pressure caused by the tensioning device.

7. The tensioning device of claim 6, the interior fitting includes at least one cushion with at least one cover and which has at least two air-conditioned zones at a surface that faces toward a user, between which zones at least one longish recess is provided into which the cover is at least partially pulled.

8. The tensioning device of claim 7, wherein the interior fitting comprises a seat, characterized in that the seat has at least one tensioning device to pull at least part of the cover into the recess such that the at least one recess is spanned by an air-ducting means despite the cover.
